(19) United States
(12) Patent Application Publication
(10) Pub. No.: US 2010/0177053 A2
(43) Pub. Date: Jul. 15, 2010

(54) METHOD AND APPARATUS FOR CONTROL OF MULTIPLE DEGREES OF FREEDOM OF A DISPLAY

(76) Inventor: Taizo Yasutake, Cupertino, CA (US)

Correspondence Address: INGRASSIA FISHER & LORENZ, P.C. (SYNA), 7010 E. Cochise Road, SCOTTSDALE, AZ, 85253, UNITED STATES, 480-385-5060, 480-385-5061, docketing@ifllaw.com

(21) Appl. No.: 12/432,891

(22) Filed: Apr. 30, 2009

Related U.S. Application Data
(60) Provisional application No. 61/127,139, filed on May 9, 2008.

(51) Int. Cl. G06F 3/041

(52) U.S. Cl. 345/173

(57) ABSTRACT

A method for controlling multiple degrees of freedom of a display using a single contiguous sensing region of a sensing device is disclosed. The single contiguous sensing region is separate from the display. The method comprises: detecting a gesture in the single contiguous sensing region; causing rotation about a first axis of the display if the gesture is determined to comprise multiple input objects concurrently traveling along a second direction; causing rotation about a second axis of the display if the gesture is determined to comprise multiple input objects concurrently traveling along a first direction; and causing rotation about a third axis of the display if the gesture is determined to be a type of gesture that comprises multiple input objects. The first direction may be nonparallel to the second direction.

### PRIORITY DATA

This application claims priority of U.S. Provisional Patent Application Ser. No. 61/127,139, which was filed on May 9, 2008, and is incorporated herein by reference.

### FIELD OF THE INVENTION

This invention generally relates to electronic devices, and more specifically relates to input devices such as proximity sensor devices.

### BACKGROUND OF THE INVENTION

Proximity sensor devices (also commonly called touchpads or touch sensor devices) are widely used in a variety of electronic systems. A proximity sensor device typically includes a sensing region, often demarked by a surface, which uses capacitive, resistive, inductive, optical, acoustic and/or other technology to determine the presence, location and/or motion of one or more fingers, styli, and/or other objects. The proximity sensor device, together with finger(s) and/or other object(s), may be used to provide an input to the electronic system. For example, proximity sensor devices are used as input devices for larger computing systems, such as those found integral within notebook computers or peripheral to desktop computers. Proximity sensor devices are also used in smaller systems, including handheld systems such as personal digital assistants (PDAs), remote controls, digital cameras, video cameras, communication systems such as wireless telephones and text messaging systems. Increasingly, proximity sensor devices are used in media systems, such as CD, DVD, MP3, video or other media recorders or players.

Many electronic systems include a user interface (UI) and an input device for interacting with the UI (e.g., interface navigation). A typical UI includes a screen for displaying graphical and/or textual elements. The increasing use of this type of UI has led to a rising demand for proximity sensor devices as pointing devices. In these applications, the proximity sensor device may function as a value adjustment device, cursor control device, selection device, scrolling device, graphics/character/handwriting input device, menu navigation device, gaming input device, button input device, keyboard and/or other input device. One common application for a proximity sensor device is as a touch screen. In a touch screen, the proximity sensor is combined with a display screen for displaying graphical and/or textual elements. Together, the proximity sensor and display screen function as the user interface.

There is a continuing need for improvements in input devices. In particular, there is a continuing need for improvements in the usability of proximity sensors as input devices in UI applications.

### BRIEF SUMMARY OF THE INVENTION

Systems and methods for controlling multiple degrees of freedom of a display, including rotational degrees of freedom, are disclosed.

A program product is disclosed. The program product comprises a sensor program for controlling multiple degrees of freedom of a display in response to user input in a sensing region separate from the display, and computer-readable media bearing the sensor program. The sensor program is configured to: receive indicia indicative of user input by one or more input objects in the sensing region; indicate a quantity of translation along a first axis of the display in response to a determination that the user input comprises motion of a single input object having a component in a first direction; and indicate rotation about the first axis of the display in response to a determination that the user input comprises contemporaneous motion of multiple input objects having a component in the second direction. The second direction may be any direction not parallel to the first direction, including substantially orthogonal to the first direction. The quantity of translation along the first axis of the display may be based on an amount of the component in the first direction. The rotation about the first axis of the display may be based on an amount of the component in the second direction.

A method for controlling multiple degrees of freedom of a display using a single contiguous sensing region of a sensing device is disclosed. The single contiguous sensing region is separate from the display. The method comprises: detecting a gesture in the single contiguous sensing region; causing rotation about a first axis of the display if the gesture is determined to comprise multiple input objects concurrently traveling along a second direction; causing rotation about a second axis of the display if the gesture is determined to comprise multiple input objects concurrently traveling along a first direction; and causing rotation about a third axis of the display if the gesture is determined to be another type of gesture that comprises multiple input objects. The first direction may be nonparallel to the second direction.

A proximity sensing device having a single contiguous sensing region is disclosed. The single contiguous sensing region is usable for controlling multiple degrees of freedom of a display separate from the single contiguous sensing region. The proximity sensing device comprises: a plurality of sensor electrodes configured for detecting input objects in the single contiguous sensing region; and a controller in communicative operation with plurality of sensor electrodes. The controller is configured to: receive indicia indicative of one or more input objects performing a gesture in the single contiguous sensing region; cause rotation about a first axis of the display if the gesture is determined to comprise multiple input objects concurrently traveling along a second direction; cause rotation about a second axis of the display if the gesture is determined to comprise multiple input objects concurrently traveling along a first direction; and cause rotation about a third axis of the display if the gesture is determined to be another type of gesture that comprises multiple input objects. The first direction may be nonparallel to the second direction

### BRIEF DESCRIPTION OF DRAWINGS

The preferred exemplary embodiment of the present invention will hereinafter be described in conjunction with the appended drawings, where like designations denote like elements, and:

FIG. 1 is a block diagram of an exemplary system including an input device in accordance with an embodiment of the invention;

FIG. 2 is a block diagram of an exemplary program product implementation in accordance with an embodiment of the invention;

FIG. 3 shows a laptop notebook computer system with an implementation in accordance with an embodiment of the invention, along with exemplary coordinate references;

FIGS. 4-8 show exemplary input object trajectories and resulting translational DOF control in exemplary systems in accordance with embodiments of the invention;

FIGS. 9-11 show exemplary input trajectories and resulting rotational DOF control in exemplary systems in accordance with embodiments of the invention;

FIGS. 12-16 show input devices with region-based continuation control capability, in accordance with embodiments of the invention;

FIGS. 17a-17c show input devices with change-in-input-object-count continuation control capability, in accordance with embodiments of the invention;

FIG. 18 shows an input device region-based control mode switching capability, in accordance with an embodiment of the invention;

FIG. 19 shows an input device capable of accepting simultaneous input by three input object to control functions other than degrees of freedom, such as to control avatar face expressions, in accordance with an embodiment of the invention;

FIGS. 20-21 show input devices capable of accepting simultaneous input by three input objects, in accordance with embodiment of the invention;

FIG. 22 shows an input device capable of accepting input by single input objects for controlling multiple degrees of freedom, in accordance with an embodiment of the invention;

FIGS. 23-24 are flow charts of methods in accordance with embodiments of the invention; and

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various aspects of the present invention provide input devices and methods that facilitate improved usability. Specifically, the input devices and methods relate user input to the input devices and resulting actions on displays. As one example, user input in sensing regions of the input devices and methods of processing the user input allow users to interact with electronic systems, thus providing more enjoyable user experiences and improved performance.

As discussed, embodiments of this invention may be used for multi-dimensional navigation and control. Some embodiments enable multiple degrees of freedom (e.g. six degrees of freedom, or 6 DOF, in 3D space) control using input by a single object to a proximity sensor. In 3D space, the six degrees of freedom is usually used to refer to the motions available to a rigid body. This includes the ability to translate in three axes (e.g. move forward/backward, up/down) and rotation about the three axes (e.g. roll, yaw, pitch). Other embodiments enable multiple degree of freedom control using simultaneous input by multiple objects to a proximity sensor. These can facilitate user interaction for various computer applications, including three dimensional (3D) computer graphics applications. Embodiments of this invention enable not only control of multiple DOF using proximity sensors, but also a broad array of 3D related or other commands. The 3D related or other commands may be available in other modes, which may be switched to with various mode switching inputs, including input with multiple objects or specific gestures.

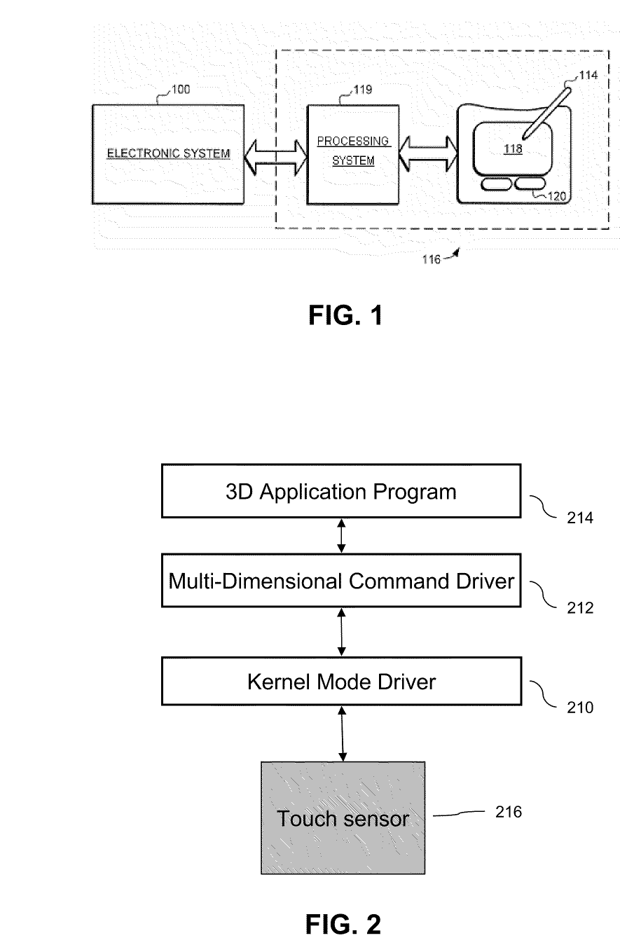

Turning now to the figures, FIG. 1 is a block diagram of an exemplary electronic system 100 that is coupled to an input device 116, shown as a proximity sensor device (also often referred to as a touch pad or a touch sensor). As used in this document, the terms “electronic system” and “electronic device” broadly refers to any type of system capable of processing information. An input device associated with an electronic system can be implemented as part of the electronic system, or coupled to the electronic system using any suitable technique. As a non-limiting example, the electronic system may comprise another input device (such as a physical keypad or another touch sensor device). Additional non-limiting examples of the electronic system include personal computers such as desktop computers, laptop computers, portable computers, workstations, personal digital assistants, video game machines. Examples of the electronic system also include communication devices such as wireless phones, pagers, and other messaging devices. Other examples of the electronic system include media devices that record and/or play various forms of media, including televisions, cable boxes, music players, digital photo frames, video players, digital cameras, video camera. In some cases, the electronic system is peripheral to a larger system. For example, the electronic system could be a data input device such as a remote control, or a data output device such as a display system, that communicates with a computing system using a suitable wired or wireless technique.

The elements are communicatively coupled to the electronic system, and the parts of the electronic system, may communicate via any combination of buses, networks, and other wired or wireless interconnections. For example, an input device may be in operable communication with its associated electronic system through any type of interface or connection. To list several non-limiting examples, available interfaces and connections include I²C, SPI, PS/2, Universal Serial Bus (USB), Bluetooth, RF, IRDA, and any other type of wired or wireless connection.

The various elements (e.g. processors, memory, etc.) of the electronic system may be implemented as part of the input device associated with it, as part of a larger system, or as a combination thereof. Additionally, the electronic system could be a host or a slave to the input device. Accordingly, the various embodiments of the electronic system may include any type of processor, memory, or display, as needed.

Returning now to FIG. 1, the input device 116 includes a sensing region 118. The input device 116 is sensitive to input by one or more input objects (e.g. fingers, styli, etc.), such as the position of an input object 114 within the sensing region 118. “Sensing region” as used herein is intended to broadly encompass any space above, around, in and/or near the input device in which sensor(s) of the input device is able to detect user input. In a conventional embodiment, the sensing region of an input device extends from a surface of the sensor of the input device in one or more directions into space until signal-to-noise ratios prevent sufficiently accurate object detection. The distance to which this sensing region extends in a particular direction may be on the order of less than a millimeter, millimeters, centimeters, or more, and may vary significantly with the type of sensing technology used and the accuracy desired. Thus, embodiments may require contact with the surface, either with or without applied pressure, while others do not. Accordingly, the sizes, shapes, and locations of particular sensing regions may vary widely from embodiment to embodiment.

Sensing regions with rectangular two-dimensional projected shape are common, and many other shapes are possible. For example, depending on the design of the sensor array and surrounding circuitry, shielding from any input objects, and the like, sensing regions may be made to have two-dimensional projections of other shapes. Similar approaches may be used to define the three-dimensional shape of the sensing region. For example, any combination of sensor design, shielding, signal manipulation, and the like may effectively define a sensing region 118 that extends some distance away from the sensor.

In operation, the input device 116 suitably detects one or more input objects (e.g. the input object 114) within the sensing region 118. The input device 116 thus includes a sensor (not shown) that utilizes any combination sensor components and sensing technologies to implement one or more sensing regions (e.g. sensing region 118) and detect user input such as presences of object(s). Input devices may include any number of structures, such as one or more sensor electrodes, one or more other electrodes, or other structures adapted to detect object presence. As several non-limiting examples, input devices may use capacitive, resistive, inductive, surface acoustic wave, and/or optical techniques. Many of these techniques are advantageous to ones requiring moving mechanical structures (e.g. mechanical switches) as they may have a substantially longer usable life.

For example, sensor(s) of the input device 116 may use multiple arrays or other patterns of capacitive sensor electrodes to support any number of sensing regions 118. As another example, the sensor may use capacitive sensing technology in combination with resistive sensing technology to support the same sensing region or different sensing regions. Examples of the types of technologies that may be used to implement the various embodiments of the invention may be found in U.S. Pat. Nos. 5,543,591, 5,648,642, 5,815,091, 5,841,078, and 6,249,234.

In some resistive implementations of input devices, a flexible and conductive top layer is separated by one or more spacer elements from a conductive bottom layer. A voltage gradient is created across the layers. Pressing the flexible top layer in such implementations generally deflects it sufficiently to create electrical contact between the top and bottom layers. These resistive input devices then detect the position of an input object by detecting the voltage output due to the relative resistances between driving electrodes at the point of contact of the object.

In some inductive implementations of input devices, the sensor picks up loop currents induced by a resonating coil or pair of coils, and use some combination of the magnitude, phase and/or frequency to determine distance, orientation or position.

In some capacitive implementations of input devices, a voltage is applied to create an electric field across a sensing surface. These capacitive input devices detect the position of an object by detecting changes in capacitance caused by the changes in the electric field due to the object. The sensor may detect changes in voltage, current, or the like.

As an example, some capacitive implementations utilize resistive sheets, which may be uniformly resistive. The resistive sheets are electrically (usually ohmically) coupled to electrodes that receive from the resistive sheet. In some embodiments, these electrodes may be located at corners of the resistive sheet, provide current to the resistive sheet, and detect current drawn away by input devices via capacitive coupling to the resistive sheet. In other embodiments, these electrodes are located at other areas of the resistive sheet, and drive or receive other forms of electrical signals. Depending on the implementation, sometimes the sensor electrodes are considered to be the resistive sheets, the electrodes coupled to the resistive sheets, or the combinations of electrodes and resistive sheets.

As another example, some capacitive implementations utilize transcapacitive sensing methods based on the capacitive coupling between sensor electrodes. Transcapacitive sensing methods are sometimes also referred to as “mutual capacitance sensing methods.” In one embodiment, a transcapacitive sensing method operates by detecting the electric field coupling one or more transmitting electrodes with one or more receiving electrodes. Proximate objects may cause changes in the electric field, and produce detectable changes in the transcapacitive coupling. Sensor electrodes may transmit as well as receive, either simultaneously or in a time multiplexed manner. Sensor electrodes that transmit are sometimes referred to as the “transmitting sensor electrodes,” “driving sensor electrodes,” “transmitters,” or “drivers”—at least for the duration when they are transmitting. Other names may also be used, including contractions or combinations of the earlier names (e.g. “driving electrodes” and “driver electrodes.” Sensor electrodes that receive are sometimes referred to as “receiving sensor electrodes,” “receiver electrodes,” or “receivers”—at least for the duration when they are receiving. Similarly, other names may also be used, including contractions or combinations of the earlier names. In one embodiment, a transmitting sensor electrode is modulated relative to a system ground to facilitate transmission. In another embodiment, a receiving sensor electrode is not modulated relative to system ground to facilitate receipt.

In FIG. 1, the processing system (or “processor”) 119 is coupled to the input device 116 and the electronic system 100. Processing systems such as the processing system 119 may perform a variety of processes on the signals received from the sensor(s) of input devices such as the input device 116. For example, processing systems may select or couple individual sensor electrodes, detect presence/proximity, calculate position or motion information, or interpret object motion as gestures. Processing systems may also determine when certain types or combinations of object motions occur in sensing regions.

The processing system 119 may provide electrical or electronic indicia based on positional information of input objects (e.g. input object 114) to the electronic system 100. In some embodiments, input devices use associated processing systems to provide electronic indicia of positional information to electronic systems, and the electronic systems process the indicia to act on inputs from users. One example system response is moving a cursor or other object on a display, and the indicia may be processed for any other purpose. In such embodiments, a processing system may report positional information to the electronic system constantly, when a threshold is reached, in response criterion such as an identified stroke of object motion, or based on any number and variety of criteria. In some other embodiments, processing systems may directly process the indicia to accept inputs from the user, and cause changes on displays or some other actions without interacting with any external processors.

In this specification, the term “processing system” is defined to include one or more processing elements that are adapted to perform the recited operations. Thus, a processing system (e.g. the processing system 119) may comprise all or part of one or more integrated circuits, firmware code, and/or software code that receive electrical signals from the sensor and communicate with its associated electronic system (e.g. the electronic system 100). In some embodiments, all processing elements that comprise a processing system are located together, in or near an associated input device. In other embodiments, the elements of a processing system may be physically separated, with some elements close to an associated input device, and some elements elsewhere (such as near other circuitry for the electronic system). In this latter embodiment, minimal processing may be performed by the processing system elements near the input device, and the majority of the processing may be performed by the elements elsewhere, or vice versa.

Furthermore, a processing system (e.g. the processing system 119) may be physically separate from the part of the electronic system (e.g. the electronic system 100) that it communicates with, or the processing system may be implemented integrally with that part of the electronic system. For example, a processing system may reside at least partially on one or more integrated circuits designed to perform other functions for the electronic system aside from implementing the input device.

In some embodiments, the input device is implemented with other input functionality in addition to any sensing regions. For example, the input device 116 of FIG. 1 is implemented with buttons 120 or other input devices near the sensing region 1118. The buttons 120 may be used to facilitate selection of items using the proximity sensor device, to provide redundant functionality to the sensing region, or to provide some other functionality or non-functional aesthetic effect. Buttons form just one example of how additional input functionality may be added to the input device 116. In other implementations, input devices such as the input device 116 may include alternate or additional input devices, such as physical or virtual switches, or additional sensing regions. Conversely, in various embodiments, the input device may be implemented with only sensing region input functionality.

Likewise, any positional information determined by the processing system may be any suitable indicia of object presence. For example, processing systems may be implemented to determine “zero-dimensional” 1-bit positional information (e.g. near/far or contact/no contact) or “one-dimensional” positional information as a scalar (e.g. position or motion along a sensing region). Processing systems may also be implemented to determine multi-dimensional positional information as a combination of values (e.g. two-dimensional horizontal/vertical axes, three-dimensional horizontal/vertical/depth axes, angular/radial axes, or any other combination of axes that span multiple dimensions), and the like. Processing systems may also be implemented to determine information about time or history.

Furthermore, the term “positional information” as used herein is intended to broadly encompass absolute and relative position-type information, and also other types of spatial-domain information such as velocity, acceleration, and the like, including measurement of motion in one or more directions. Various forms of positional information may also include time history components, as in the case of gesture recognition and the like. As will be described in greater detail below, positional information from processing systems may be used to facilitate a full range of interface inputs, including use of the proximity sensor device as a pointing device for cursor control, scrolling, and other functions.

In some embodiments, an input device such as the input device 116 is adapted as part of a touch screen interface. Specifically, a display screen is overlapped by at least a portion of a sensing region of the input device, such as the sensing region 118. Together, the input device and the display screen provide a touch screen for interfacing with an associated electronic system. The display screen may be any type of electronic display capable of displaying a visual interface to a user, and may include any type of LED (including organic LED (OLED)), CRT, LCD, plasma, EL or other display technology. When so implemented, the input devices may be used to activate functions on the electronic systems. In some embodiments, touch screen implementations allow users to select functions by placing one or more objects in the sensing region proximate an icon or other user interface element indicative of the functions. The input devices may be used to facilitate other user interface interactions, such as scrolling, panning, menu navigation, cursor control, parameter adjustments, and the like. The input devices and display screens of touch screen implementations may share physical elements extensively. For example, some display and sensing technologies may utilize some of the same electrical components for displaying and sensing.

It should be understood that while many embodiments of the invention are to be described herein the context of a fully functioning apparatus, the mechanisms of the present invention are capable of being distributed as a program product in a variety of forms. For example, the mechanisms of the present invention may be implemented and distributed as a sensor program on computer-readable media. Additionally, the embodiments of the present invention apply equally regardless of the particular type of computer-readable medium used to carry out the distribution. Examples of computer-readable media include various discs, memory sticks, memory cards, memory modules, and the like. Computer-readable media may be based on flash, optical, magnetic, holographic, or any other storage technology.

Referring now to FIG. 2, FIG. 2 shows a block diagram of an exemplary program product implementation in accordance with an embodiment of the invention. For example, embodiments may include one or more data processing programs in the generation or implementation of commands. Each data processing program may include a combination of kernel mode device drivers and user application level drivers that send messages to target programs.

FIG. 2 depicts one embodiment that manages data packets from a touch sensor 216 and for controlling a 3D application program 214. In the embodiment of FIG. 2, the touch sensor 216 provides data about user input to a kernel mode driver 210. The kernel mode driver 210 processes the data from the touch sensor 216 and passes processed data to a multi-dimensional command driver 212. The multi-dimensional command driver 212 then communicates commands to a 3D application program 214. Although the communications between the different blocks are shown as bilateral in FIG. 2, some or all of the communication channels may be unilateral in some embodiments.

The kernel mode driver 210 is typically part of the operating system, and includes a device driver module (not shown) that acquires data from of the touch sensor 216. For example, a MICROSOFT WINDOWS operating system may provide built-in kernel mode drivers for acquiring data packets of particular types from input devices. Any of the communications and connections discussed above can be used in transferring data between the kernel mode driver 210 and the touch sensor 216, and oftentimes USB or PS/2 is used

The multi-dimensional command driver 212, which may also include a device driver module (not shown), receives the data from the touch sensor 216. The multi-dimensional command driver 212 also usually executes the following computational steps. The multi-dimensional command driver 212 interprets the user input, such as a multi-finger gesture. For example, the multi-dimensional command driver 212 may determine the number of finger touch points by counting the number of input objects sensed or by distinguishing finger touches from touches by other objects. As other examples, the multi-dimensional command driver 212 may determine local positions or trajectories of each object sensed or a subset of the objects sensed. For example, a subset of the objects may consist of a specific type of input object, such as fingers. As another example, the multi-dimensional command driver 212 may identify particular gestures such as finger taps.

The multi-dimensional command driver 212 of FIG. 2 also generates multi-dimensional commands for 3D application program 214, based on the interpretation of the user input. If the 3D application program 214 uses data in a specific format, the multi-dimensional command driver 212 may send the commands in that specific format. For example, if the 3D application program 214 is developed to use the touch sensor data as standard input data, the multi-dimensional command driver 212 may send commands as touch sensor data. In such a case, the multi-dimensional command driver 212 may not interpret data from the touch sensor 216 for the 3D application program 214, and may instead just pass along the touch sensor data in as-received or modified form to the 3D application program 214.

If the 3D application program 214 does not recognize the touch sensor data as standard input data, then the multi-dimensional command driver 212 or another part of the system may translate the data for the 3D application program 214. For example, the multi-dimensional command driver 212 may send specific messages to the operating system, which then directs the 3D application program 214 to execute the multi-dimensional commands. These specific messages may emulate messages of keyboards, mice, or some other device that the operating system understands. In such a case, the 3D application program 214 processes the directions from the operating system as if they were from the emulated device(s). This approach enables the control of the 3D application program 214 (e.g. to update a 3D rendering process) according to user inputs understood by the multi-dimensional command driver 212, even if the 3D application program 214 is not specifically programmed to operate with the multi-dimensional command driver 212 or the touch sensor 216.

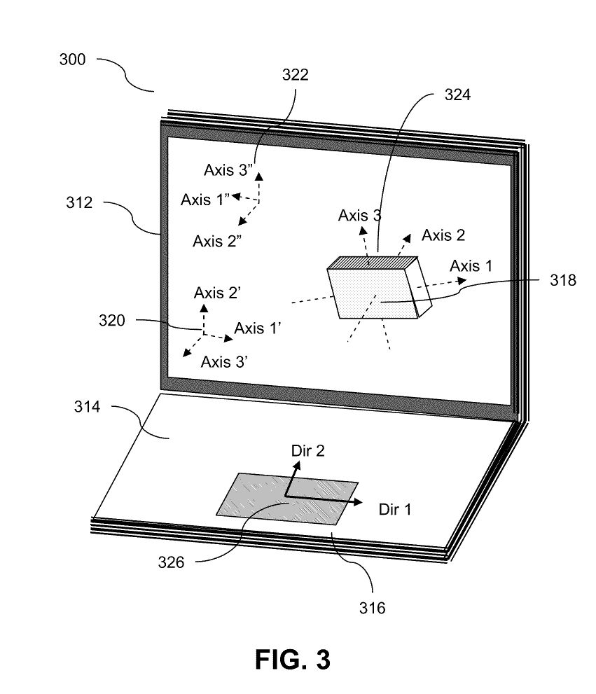

FIG. 3 shows a laptop notebook computer system 300 with an implementation in accordance with an embodiment of the invention. The system 300 includes a display screen 312 usable for showing a variety of displays. The display screen 312 is coupled to a base 314 that houses input device 316 (shown as a laptop touch pad). The displays of display screen 312 are controllable by input to input device 316. The sensing region (not shown) of input device 316 is thus separate from any displays of display screen 312. That is, the sensing region of input device 316 is at least partially non-overlapped with the display on display screen 312 that is to be affected by input to the sensing region. The non-overlapped portion of the sensing region may be used to control the degrees of freedom of the display. In many embodiments, the sensing region of input device 316 is completely non-overlapped with the display.

Although sensing regions and displays are in this separate configuration in most embodiments, the sensing region of input device 316 may be overlapped with the display that it is configured to control in some embodiments.

FIG. 3 also shows exemplary coordinate references 320, 322, and 324. FIG. 3 also shows a Cartesian touch pad coordinate system 326, with substantially orthogonal directions Dir 1 and Dir 2 imposed on the input device 316. This coordinate system is used to describe the operation of the input device 316 below, and is merely exemplary. Other types of coordinate systems may be used.

The input device 316 can be used for mouse equivalent 2D commands. The laptop notebook computer may have other input options that are not shown, such as keys typically found in keyboards, mechanical or capacitive switches, and buttons associated with the input device 316 for emulating left and right mouse buttons. The input device 316 generally accepts input by a single finger for 2D control, although it may accept single-finger input for controlling degrees of freedom in other dimensional spaces (e.g. a single dimension, in three dimensions, or in some other number of dimensions). In some embodiments, mode switching input to the input device 316 or some other part of the system 300 is used to switch between 2D and 3D control modes, or between different 3D control modes.

In a 3D control mode, the input device 316 may be used to control multiple degrees of freedom of a display shown by the display screen. The multiple degrees of freedom controlled may be within any reference system associated with the display. Three such reference systems are shown in FIG. 3. Reference system 320 has three orthogonal axes (Axis 1′, Axis 2′, and Axis 3′) that define a 3D space that may be held static and used with whatever is displayed on display screen 312. That is, 3D control commands may be interpreted with respect to reference system 320, regardless of what is displayed and oriented.

Reference system 322 also has three orthogonal axes (Axis 1″, Axis 2″, and Axis 3″) that define a 3D coordinate system. Reference system 322 is a viewpoint-based system. That is, 3D control commands using reference system 322 controls how that viewpoint moves. As the viewpoint rotates, for example, the reference system 322 also rotates.

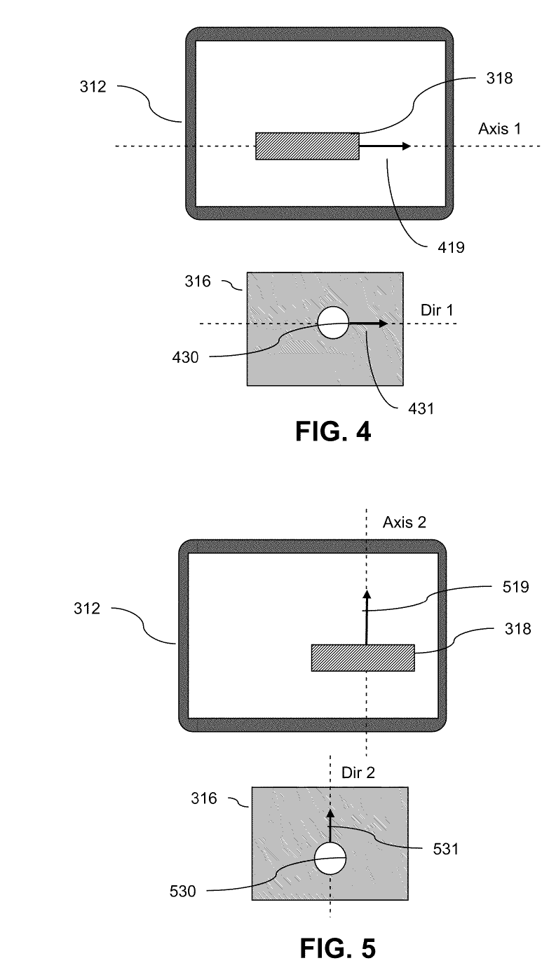

Reference system 324 has three orthogonal axes (Axis 1, Axis 2, and Axis 3) that define a 3D coordinate system. Reference system 324 is an object-based system, as indicated by the controlled object 318. Here, controlled object 318 is part or all of a display. Specifically, controlled object 318 is shown as a box with differently-shaded sides presented by display screen 312. 3D control commands using reference system 324 controls how the controlled object 318 moves. As controlled object 318 rotates, for example, the reference system 324 also rotates. That is, the reference system 324 rotates with the controlled object 318. For example, for FIGS. 4-8, the controlled object 318 has been rotated such that Axis 3 is pointing substantially orthogonal to the display screen 312 (shown as out of the page).

In some cases where the reference system is mapped to a Cartesian system, Axis 1 may be associated with “X,” Axis 2 may be associated with “Z,” and Axis 3 may be associated with “Y.” In some of those cases, rotation about Axis 1 may be referred to as “Pitch” or “rotation about the X-axis,” rotation about Axis 2 may be referred to as “Yaw” or “rotation about the Z-axis,” and rotation about Axis 3 may be referred to as “Roll” or “rotation about the Y-axis.”

Although the above examples use reference systems with orthogonal axes, other reference systems with non-orthogonal axes may be used, as long as the axes define a 3D space.

The discussion that follows often uses object-based reference systems for ease and clarity of explanation. However, other reference systems, including those based on display screens (e.g. reference system 320) or viewpoints (e.g. reference system 322), can also be used. Similarly, although system 300 is shown as a notebook computer, the embodiments described below can be implemented in any appropriate electronic system.

Some embodiments enable users to define or modify the types of inputs that would cause particular degree of freedom responses. For example, various embodiments enable users to switch the type of gesture that causes rotation about the one axis with one or more of the types of gesture that causes rotation about the other two axes. As a specific example, in some cases of 3D navigation in computer graphics applications, rotation about Axis 2 or its analog may be used rarely. It may be useful to enable users or applications to re-associate the gesture usually associated with rotation about Axis 2 (e.g. motion of multiple objects along Dir 1) with rotation about Axis 3. This different association may be preferred for some users for efficiency, ergonomic, or some other reasons.

FIGS. 4-8 show exemplary input object trajectories and resulting translational DOF control in exemplary systems in accordance with embodiments of the invention. Note that the controlled object 318 is oriented in such a way that Axis 3 is substantially perpendicular to the display screen 312 (shown as pointing out of the page for FIGS. 4-8)

FIG. 4 depicts movement of a single input object 430 along path 431 that has a component in Dir 1. In fact, path 431 is shown paralleling Dir 1 in FIG. 4, although that need not be the case. This movement by input object 430 causes the controlled object 318 to move in a path 419 that parallels Axis 1 (i.e. along Axis 1). The input device 316 may indicate a quantity of translation along a first axis of the display in response to a determination that the user input comprises motion of a single input object having a component in a first direction. The quantity of translation along the first axis of the display may be based on an amount that the motion of the single input object traverses in the first direction (i.e. the component in the first direction). As non-limiting examples, the translation of the amount of motion of the input object to the quantity of translation may be a one-to-one relationship, a linear relationship with a single gain factor, a piecewise linear relationship with multiple gain factors, a variety of nonlinear relationships, any combination of these, and the like.

FIG. 5 depicts movement of a single input object 530 in a path 531 that has a component in Dir 2. In fact, path 531 is shown paralleling Dir 2, although that need not be the case. This movement by input object 530 causes controlled object 318 to move in a path 519 that parallels Axis 2 (along Axis 2). That is, the input device 316 may indicate a quantity of translation along a second axis of the display in response to a determination that the user input comprises motion of a single input object having a component in the second direction. The second axis may be substantially orthogonal to the first axis. The quantity of translation along the second axis of the display may be based on an amount that the motion of the single input object traverses in the second direction;

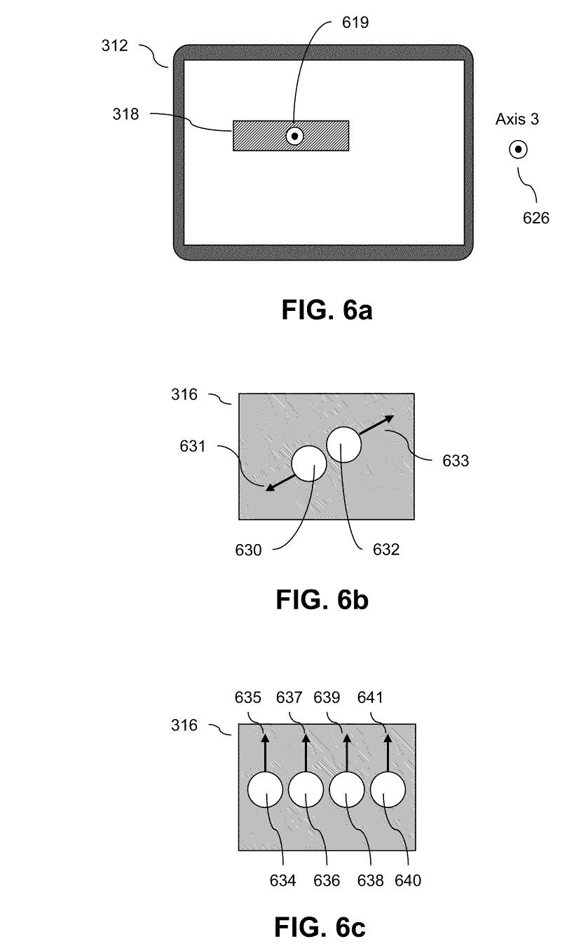

FIGS. 6a-6c illustrate two different ways that multiple input objects may move in sensing regions to cause translation along Axis 3 (along Axis 3). In FIG. 6a, the controlled object 318 is oriented such that Axis 3 (indicated by out-of-the-page arrow 626) is into and out of the page. Although FIG. 6a shows Axis 3 as positive out-of-the-page, that need not be the case; Axis 3 may be positive into the page or in a skewed direction for the same controlled object 318 in another orientation of controlled object 318. With the configuration shown in FIG. 6a, translation along Axis 3 effectively results in zooming into and zooming out from the controlled object 318.

In FIG. 6b, input objects 620 and 630 are moved along paths 631 and 633, respectively, to provide an outward pinch gesture (also called “spread”) that moves objects 620 and 630 further apart from each other. In many embodiments, this input results in the controlled object 318 moving in a direction 619, along positive Axis 3. “Causing” may be direct, and be the immediate prior cause for the response. “Causing” may also be indirect, and be some part of the proximate causal chain for the response. For example, embodiments may cause the translation by indicating, via signals or other indicia, to another element or system the translation response. With the orientation shown in FIG. 6a, this results in controlled object 318 appearing to move closer, which makes controlled object 318 larger on the display screen. Thus, for the configuration shown in FIG. 6a, this effectively zooms in toward the controlled object 318. In many embodiments, an inward pinch gesture involving input objects 620 and 630 moving closer to each other results in the controlled object moving in the other direction along Axis 3 (in the negative direction). For the configuration shown in FIG. 6a, this results in controlled object 318 appearing to move away, and effectively results in zooming out from the controlled object 318.

FIG. 6c shows an alternate input usable by some embodiments for causing translation along Axis 3. In FIG. 6c, four input objects 634, 636, 638, and 640 are moved in paths 635, 637, 639, and 641, respectively. If the system has a configuration like system 300, this movement brings input objects 634, 636, 638, and 640 toward the display screen 312. In many embodiments, such movement results in the controlled object 318 moving along the positive Axis 3 direction. In many embodiments, moving the four input objects 634, 636, 638, and 640 in paths that have components opposite paths 635, 637, 639, 641, respectively, results in the controlled object 318 moving along the negative Axis 3 direction. Again, the positive or negative result may be arbitrary, and vary between embodiments.

Some embodiments use the pinching gestures for controlling translation along Axis 3, some embodiments use the movement of four input objects for controlling translation along Axis 3, and some embodiments use both. Thus, in operation, the input device 316 may indicate translation along a third axis of the display. The third axis may be substantially orthogonal to the display. This indication may be provided in response to a determination that the user input comprises a change in separation distance of multiple input objects. Alternatively, this indication may be provided in response to a determination that the user input comprises four input objects simultaneously moving in a trajectory that brings them closer or further away from the display screen.

Again, although the above discusses control of translational degrees of freedom using on object-based reference systems (with Axis 1, Axis 2, and Axis 3), that is done for clarity of explanation. Analogies can be drawn for other reference systems, such that the same or similar input results in translation along axes of those other reference systems instead. For example, reference systems based on one or more viewpoints (e.g. reference system 322 of FIG. 3) may be used, and input such as described in association with FIGS. 4-6 may cause translation along viewpoint-based axes (e.g. Axis 1″, Axis 2″, and Axis 3″ of FIG. 3). As another example, reference systems static to the display screen (e.g. reference system 320 of FIG. 3) may be used. In such a case, input such as described in association with FIGS. 4-6 may cause translation along display screen-based axes (e.g. Axis 1′, Axis 2′, and Axis 3′ of FIG. 3). Some embodiments use only one reference system each. Other embodiments switch between multiple reference systems as appropriate, such as in response to user preference, what is displayed, what is being controlled, the input received, the application affected, and the like.

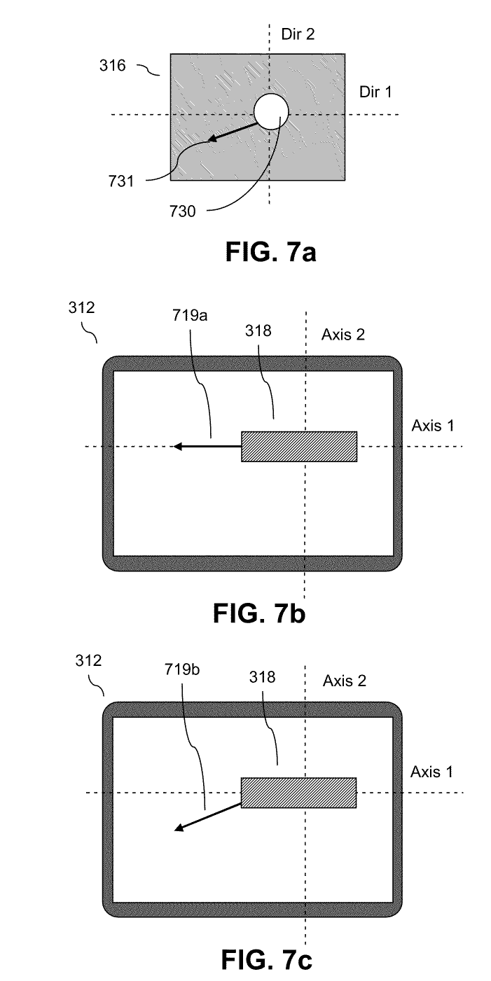

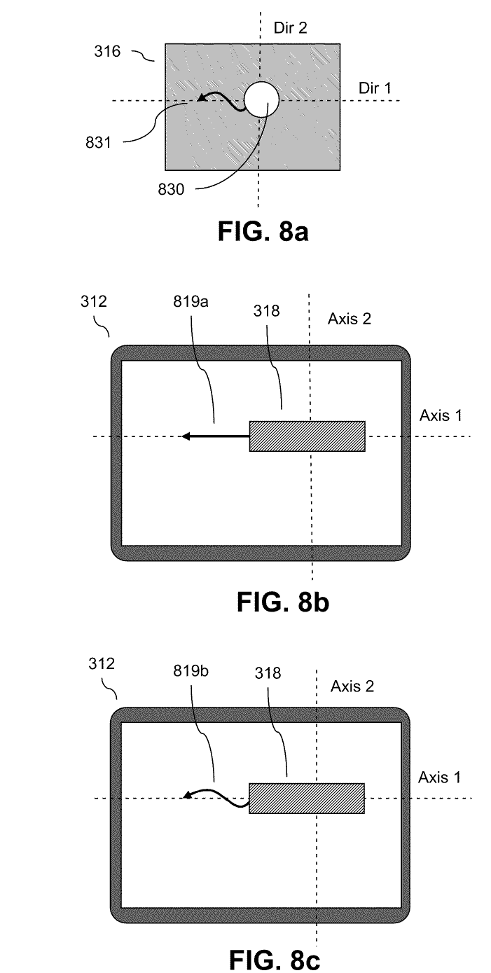

User input does not always involve object motion exactly parallel to the reference directions or reference axes. When faced with such input, the system may respond in a variety of ways. FIGS. 7-8 show some alternate responses that may be implemented in various embodiments.

FIG. 7a shows an input object 730 moving along a path 731 not parallel to either Dir 1 or Dir 2. Instead, path 731 has components along both Dir 1 and Dir 2. FIG. 7b shows one possible response for the display. In some embodiments, the controlled object 318 moves in a path 719a parallel to the axis associated with a predominant direction of the motion of input object 730. For the embodiment shown in FIG. 7b, that would be along Axis 1. In operation, the input device 316 may determine the predominant direction in a variety of ways. For example, the input device 316 may compare angles between the direction of object motion to Dir 1 or Dir 2, and select Dir 1 or Dir 2 depending on which one is closer to the object motion's direction based on which angle has smaller magnitude. As another example, the input device 316 may compare components of the object motion along Dir 1 or Dir 2, and select between Dir 1 and Dir 2 depending on which one had the larger component. For such comparisons, a single portion, multiple portions, or the entire path of travel of the input object may be used. The path of travel may be smoothed, filtered, linearized, or idealized for this analysis.

FIG. 7c shows an alternate response to the input depicted in FIG. 7a. In the embodiment shown in FIG. 7c, Axis 1 is associated with Dir 1 and Axis 2 is associated with Dir 2. In some embodiments, the controlled object 318 follows the movement of the input object 730 of FIG. 7a. Specifically, the controlled object 318 moves in a path 719b with components along both Axis 1 (associated with motion along Dir 1) and Axis 2 (associated with motion along Dir 2). In operation, the input device 316 may process the components along Dir 1 and Dir 2 together or separately to determine amount of translation along Axis 1 and Axis 2. The amount of translation indicated along Axis 1 and Axis 2 may have an aspect ratio that is the same as, or that is different from, the aspect ratio of the motion of the input object.

FIG. 8a shows an input object 830 moving in a path 831 that is not linear. Instead, the path 831 has a direction that changes over time, such that a squiggly path is traced by the input object 830. With some embodiments, the system may respond by determining a predominant direction of travel, and producing translation of the controlled object 318 in a path in the axis associated with the predominant direction. This is shown in FIG. 8b, in which the controlled object 318 is moved along path 819a that parallels Axis 1. In some embodiments, the system may respond by following the object motion, and translate object 318 in a manner that follows some type of modified object motion on screen. This is shown in FIG. 8c, in which the controlled object 318 follows a path 819b that wavers about Axis 1 in a manner similar to how path 831 wavers about Dir 1. Some embodiments may produce a combination (e.g. a superposition or some other combination) of the responses described in above in connection with FIGS. 8b and 8c. For example, some embodiments may linearize or filter out smaller changes in direction while following larger changes in direction. Smaller and larger changes may be distinguished by angle of direction change, magnitude of direction change, duration of direction change, and the like. The changes may also be gauged from a main direction, an average direction, an instantaneous direction, and the like.

FIGS. 9-11 show exemplary input trajectories and resulting rotational DOF control in exemplary systems in accordance with embodiments of the invention. FIG. 9 shows two input objects 930 and 932 with object motion along paths 931 and 933, respectively. Paths 931 and 933 both have components parallel to Dir 2. In the specific case shown in FIG. 9, paths 931 and 933 are roughly parallel trajectories that keep input objects 930 and 932 generally side by side and moving parallel to Dir 2. This causes rotation of the controlled object 318 about Axis 1. In operation, the input device 316 may indicate rotation about a first axis of the display in response to a determination that the user input comprises contemporaneous motion of multiple input objects having a component in a second direction that is substantially orthogonal to a first direction. In some embodiments, the rotation may be pre-set (e.g. a preset rate or quantity of rotation). In some embodiments, the rotation about the first axis of the display may be based on an amount of the component in the second direction.

The amount of the input's component in Dir 2 may be determined from the separate components that the different input objects 930 and 932 has along Dir 2. For example, the amount of the input's component may be a mean, max, min, or some other function or selection of the separate components of paths 931 and 933. The relationship between the amount of the component in the second direction and the rotation may involve any appropriate aspect of the rotation, including quantity, speed, or direction. The relationship may also be linear (e.g. proportional), piecewise linear (e.g. different proportional relationships), or non-linear (e.g. exponential, curvy, or stair-stepped increases as components reach different levels).

FIG. 10 shows two input objects 1030 and 1032 with object motion along paths 1031 and 1033, respectively. Paths 1031 and 1033 both have components parallel to Dir 1. In the specific case shown in FIG. 10, paths 1031 and 1033 are roughly parallel trajectories that keep input objects 1030 and 1032 generally side by side and moving parallel to Dir 1. This causes rotation of the controlled object 318 about Axis 2. In operation, the input device 316 may indicate rotation about a second axis of the display in response to a determination that the user input comprises contemporaneous motion of multiple input objects all having a component in the first direction. Similarly to the rotation about the first axis, the rotation about the second axis of the display may be pre-set, or based on an amount of the component of the multiple input objects in the first direction in any appropriate way.

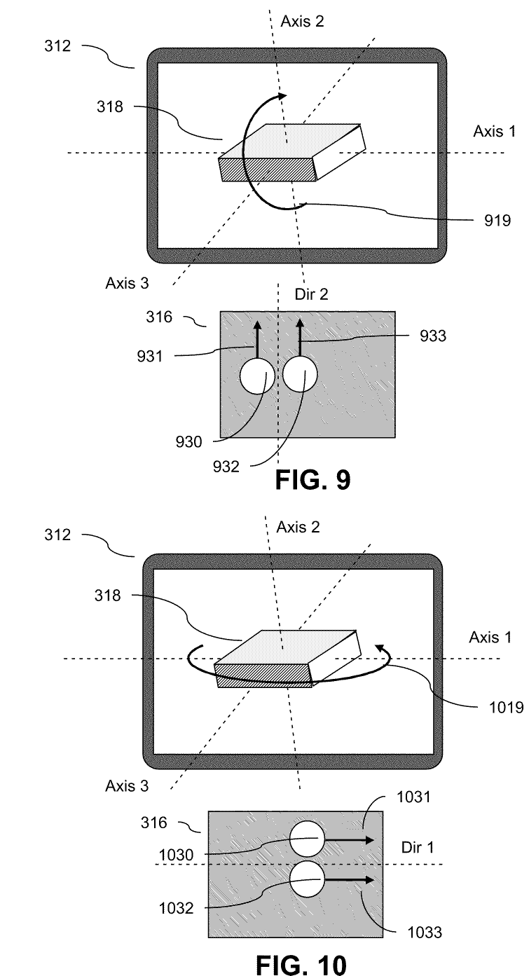

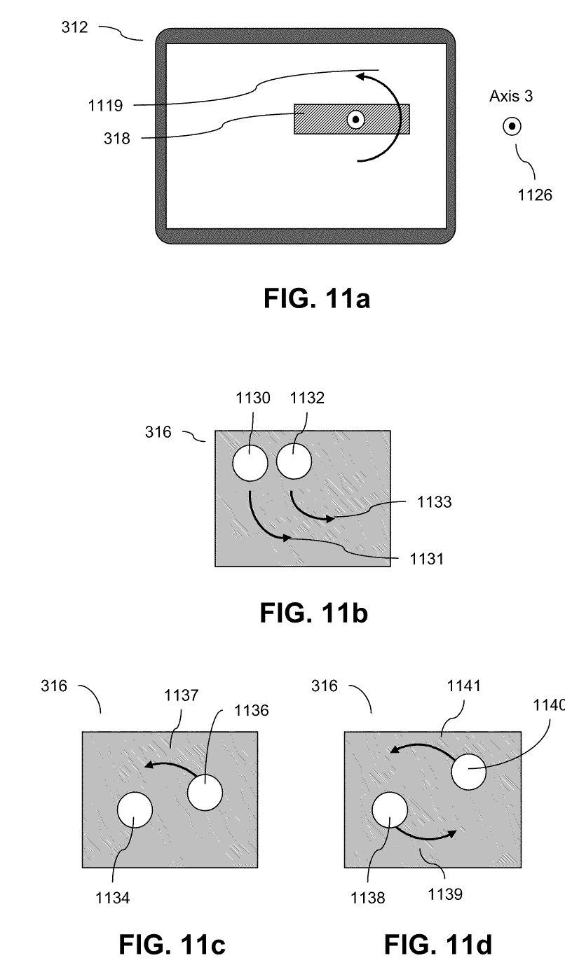

FIG. 11 illustrate different ways of providing user input including circular object motion for causing rotation about Axis 3. Specifically, the input device 316 may indicate rotation about the third axis of the display in response to a determination that the user input comprises circular motion of at least one input object of a plurality of input objects in the sensing region. It should be understood that circular motions do not require tracing exact circles or portions of circles. Rather, motions that traverse portions of or all of what would be convex loops are sufficient.

In FIG. 11a, as in FIG. 6a, the controlled object 318 is oriented such that Axis 3 (indicated by out-of-the-page arrow 1126) is into and out of the page, although it need not be the case. In FIG. 1b, input objects 1130 and 1132 are both moved in a roughly parallel trajectory that keeps input objects 1130 and 1132 generally side by side. Specifically, input objects 1130 and 1132 move in arcuate paths 1131 and 1133, respectively, to cause positive rotation about Axis 3 (rotate in direction 1119 in FIG. 1a).

In FIG. 11c, input object 1134 is held substantially still while input object 1136 is moved in a curve to cause the controlled object 318 to rotate about Axis 3 as shown by direction 1119 in FIG. 11a. In some embodiments, it is also possible to hold input object 1136 substantially stationary while moving input object 1134 to cause rotation about Axis 3. In some embodiments, rotation about Axis 3 results if the path of traversal of input object 1136 is around input object 1134. Other embodiments involve rotation about Axis 3 if the input object 1136 does not follow a path that would bring it around input object 1134. Further embodiments produce rotation about Axis 3 regardless of the relationship of the path of input object 1136 in relation to input object 1134.

In FIG. 11c, input object 1138 and input objects 1140 both move along nonlinear paths that are roughly circular to cause the controlled object 318 to rotate about Axis 3 as shown by direction 1119 in FIG. 11a. The paths 1139 and 1141 keeps input object 1138 and 1140 apart, and not side-by-side.

Embodiments of the invention may use any or all of the different ways of causing rotation about Axis 3 as discussed above. Whatever the method used, most embodiments would cause rotation about Axis 3 in the opposite direction (e.g. negative rotation about Axis 3) if the input objects are moved in an opposite way. One example is moving input objects 1130 and 1132 clockwise instead of counterclockwise. Another example is moving input object 1136 clockwise instead of counterclockwise. Yet another example is holding input object 1136 substantially still while moving input object 1134. A further example is moving input objects 1138 and 1140 clockwise instead of counterclockwise.

Analogous to what is discussed in association with FIGS. 7 and 8, paths of travel by input objects may have trajectories that combine (e.g. as superpositions or other types of combinations) aspects of those discussed in connection with FIGS. 9-11. Faced with such input, some embodiments may produce results that are associated with predominant trajectories. Other embodiments may produce combined results.

For example, in various embodiments, the input device 316 may determine if an input gesture comprises multiple input objects concurrently traveling predominantly along a second (or first) direction, and cause rotation about the first (or second) axis of the display if the gesture is determined to comprise the multiple input objects concurrently traveling predominantly along the second (or first) direction Determining if the input objects are traveling predominantly along the second direction (or the first direction) may be accomplished in many different ways. Non-limiting examples include comparing the travel of the multiple input objects with the second direction (or the first direction), examining a ratio of the input objects' travel in the first and second directions, or determining that the predominant direction is not the first direction (or the second direction).

As another example, in various embodiments, the input device 316 may determine an amount of rotation about the first axis based on an amount of travel of the multiple input objects along the second direction, and determine an amount of rotation about the second axis based on an amount of travel of the multiple input objects along the first direction. With such an approach, multiple input objects concurrently traveling along both the second and first directions would cause rotation about both the first and second axes.

Again, although the above discusses control of rotational of freedom using on object-based reference systems (with Axis 1, Axis 2, and Axis 3), that is done for clarity of explanation. Analogies can be drawn for other reference systems, such that the same or similar input results in translation along axes of those other reference systems instead.

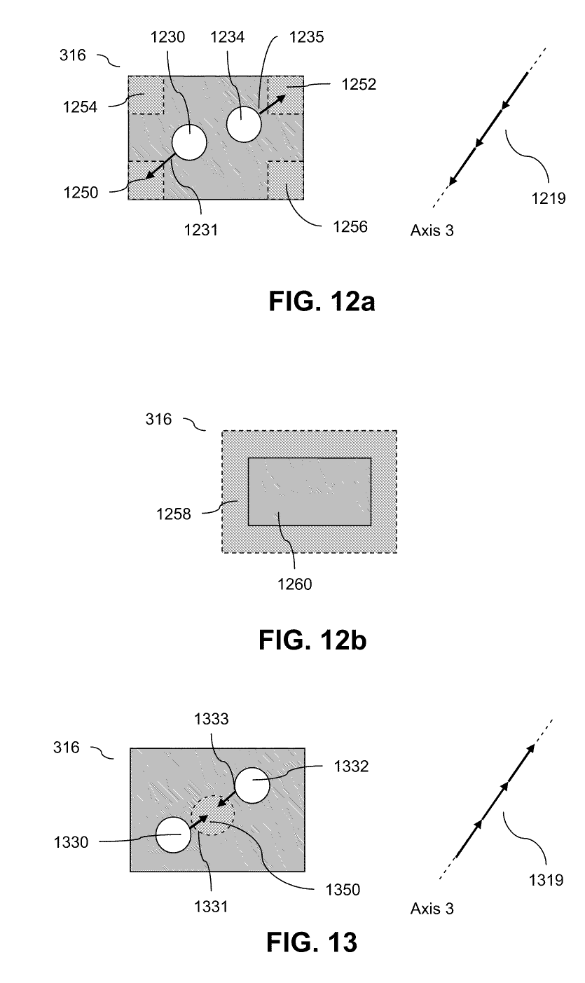

FIG. 12-16 show input devices with region-based continuation control capability, in accordance with embodiments of the invention. Continuation control capability may enable users to cause continued motion even if no further motion of any input objects occur. Depending on the implementation, that may be accomplished by setting a rate of translation, repeatedly providing a quantity of translation, not terminating a translation rate or repeated amount that was set earlier, and the like. In addition, some embodiments utilize timers, counters, and the like such that the system responds after various criteria are met (e.g. input objects in a particular region) for a reference duration of time. For example, in many embodiments, if the input objects initiate input and then move into specified region(s), then the system may respond by continuing to control the degree of freedom that was last changed. In some embodiments, that is accomplished by repeating the command last generated before the input objects reached the specified region(s). In other embodiments, that is accomplished by repeating one of the commands that was generated shortly before the input objects reached the specified region(s). The regions may be defined in various ways, including being defined during design or manufacture, defined by the electronic system or applications running on the electronic system, by user selection, and the like. Some embodiments enable users or applications to define some or all aspects of these regions.

FIGS. 12-13 depict inputs on system that accepts them for causing continued translation about the third axis. Referring now to FIG. 12a, input objects 1230 and 1234 are shown as pinching apart, following paths 1231 and 1235, respectively. The motion of input objects 1230 and 1234 brings them into extension regions 1250 and 1252, respectively. Extension regions 1250 and 1252 are shown located in opposing corner portions of a 2D projection of the sensing region of input device 316, although that need not be the case. As shown in FIG. 12a, the spreading of input objects 1230 and 1234 causes translation along Axis 3 in the direction 1219. The entering and staying of the input objects 1230 and 1234 into corner regions 1250 and 1252 causes continued translation along Axis 3 in the direction 1219. In many cases, translation continues as long as the input objects 1230 and 1234 remain in the corner regions 1250 and 1252. FIG. 12a shows another set extension regions 1254 and 1256 in opposing corner portions of the 2D projection of the sensing region of input device 316 that may be used in a similar way.

Although FIG. 12a shows two sets of extension regions (1250 and 1252, plus 1254 and 1256) in corner portions, it should be understood that any number of extension regions and locations may be used by embodiments as appropriate. As another example, as shown in FIG. 12b, the sensing region of input device 316 may have an outer region 1258 surrounding an inner region 1256. The outer region 1258 may function like the extension regions 1250 and 1252 in helping to ascertain when to produce a continued translation along Axis 3.

In some embodiments, the extension of the translation along Axis 3 is in response to user input that starts in an inner region and then reaches and remains in the extensions regions. To produce the actual extended translation the system may monitor the trajectories of the input objects, and generate continued translation using a last speed of movement. In some embodiments, the input device 316 is configured to indicate continued translation along the third axis of the display in response to a particular determination. Specifically, that particular determination includes ascertaining that the user input comprises the multiple input objects moving into and staying within extension regions after a change in separation distance of the multiple input objects (which may have resulted in earlier translation along the third axis). In many embodiments, the extension regions comprise opposing corner portions of the sensing region.

Referring now to FIG. 13, input objects 1330 and 1332 are moved along paths 1331 and 1333, respectively. This motion results in a pinch inward gesture that may cause translation along Axis 3 that is opposite to the one caused by the pinch outward gesture discussed in connection with FIG. 12. Pinching inward brings the input objects 1330 and 1332 into a same region 1350, which results in continued translation along Axis 3. In operation, the input device 316 may cause continued translation along the third axis of the display in response to input objects exhibiting particular user input. Specifically, the input device 316 may indicate continued translation in response to input objects moving into and staying in a same portion of the sensing region of the input device 316 after multiple input objects has moved relative to each other in the sensing region. The input device 316 may further require that the multiple input objects moved in such a way that a separation distance of the multiple input objects with respect to each other had changed.

The system may calculate a dynamically changing region 1350. Alternatively, the system may monitor for a pinching inward input followed by the input objects getting within a threshold distance of each other. Alternatively, the system may look for input objects that move closer to each other and eventually merge into what appears to be a larger input object. Thus, the region 1350 may not be specifically implemented with regional boundaries, but may be a mental abstraction of limitations on separation distances, increases in input object size accompanied by decreases in input object.

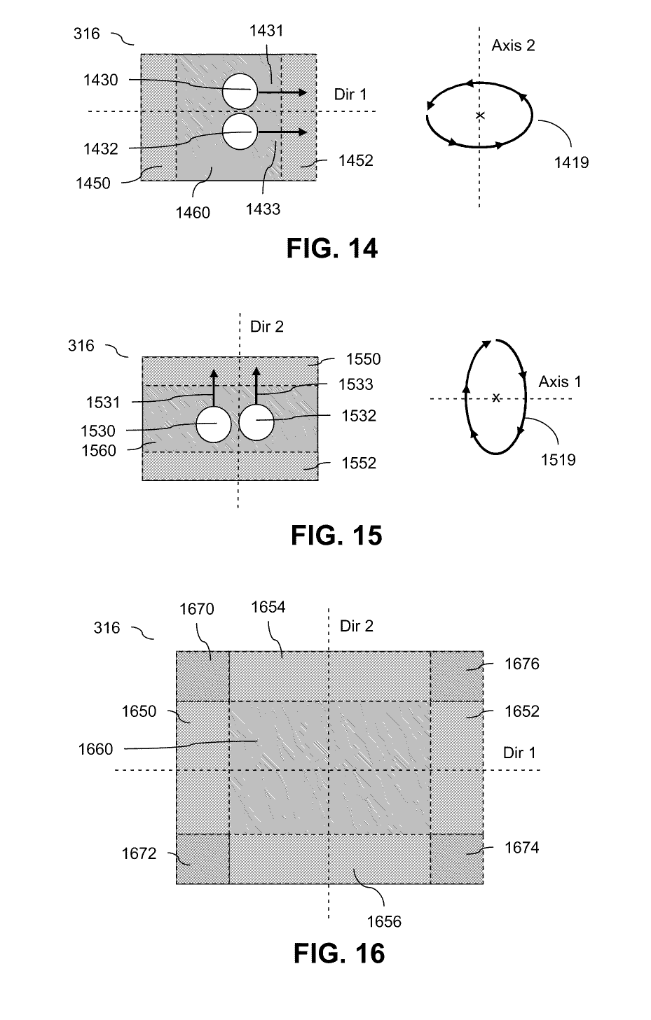

FIGS. 14-15 depict ways to generate continuing rotation using outer regions. This enables users to turn controlled objects even if input object motion has stopped, such as by reaching into an edge region of the sensing region of input device 316. In FIG. 14, the sensing region of input object 316 has been sectioned into an inner region 1460 and edge regions 1450 and 1452. Input objects 1430 and 1432 start in the inner region 1460 and move along paths 1431 and 1433, respectively. Paths 1431 and 1433 have components along Dir 1, and may cause an object (not shown) to rotate in a direction 1419 about Axis 2. Sufficient movements along paths 1431 and 1433 brings input objects 1430 and 1432 into edge region 1452, in which input objects 1430 and 1432 may stay. In response, the system may generate continued rotation about Axis 2. In many embodiments, rotation continues as long as the objects 1430 and 1432 remain in the edge region 1452.

Any of the ways discussed above to indicate extended or continued motion can also be used. For example, the system may monitor the trajectories of input objects 1430 and 1432 for this type of input history, and produce continued rotation using a speed of input object movement just before the input objects 1430 and 1432 entered the edge region 1452. As another example, the input device 316 may indicate continued rotation about the second axis in response to a particular determination. Specifically, the input device 316 may determine that the user input comprises multiple input objects moving into and staying in a set of continuation regions after the multiple input objects has moved with a component in the first direction. In many embodiments, the set of continuation regions are opposing portions of the sensing region.

Referring now to FIG. 15, a way to generate continued rotation about Axis 1 is shown that is analogous to the way depicted in FIG. 14 for generating continued rotation about Axis 2. The sensing region of input device 316 has been sectioned into inner region 1560 and edge regions 1550 and 1552. Input objects 1530 and 1532 move along paths 1531 and 1533, respectively. Movement along paths 1531 and 1533 may bring the input objects 1530 and 1532 into edge region 1550, which may result in continued rotation about Axis 1. Any of the ways discussed above to indicate extended or continued motion can also be used. For example, the input device 316 may indicate continued rotation about the first axis in response to a determination that that the user input comprises multiple input objects moving into and staying in a set of continuation regions after the multiple input objects has moved with a component in the second direction. In many embodiments, the set of continuation regions are opposing portions of the sensing region.

Continuation and extension regions may be used separately or together. FIG. 16 shows an embodiment of input device 316 that has continuation regions for both rotation about Axis 1 and Axis 2. Specifically, the sensing region of input device 316 has been defined into an inner region 1660 and edge regions 1650, 1652, 1654, and 1656. The edge regions overlap in corner regions 1670, 1672, 1674, and 1676. In such an embodiment, input such as described in connection with FIGS. 14-15 that enter any of the edge regions 1650, 1652, 1653, and 1656 may cause continued rotation about Axis 1 or Axis 2 as appropriate. User input that results in input objects entering any of the corner regions 1670, 1672, 1674, 1676 can produce no rotation, rotation about either Axis 1 or Axis 2 (e.g. based on which rotation was caused prior to entering the corner regions), or combined (e.g. superimposed or otherwise combined) rotation about both Axis 1 and Axis 2.

Thus, some embodiments of input device 316 may have a single contiguous sensing region that comprises a first set of continuation regions and a second set of continuation regions. The first set of continuation regions may be located at first opposing outer portions of the single contiguous sensing region and the second set of continuation regions may be located at second opposing outer portions of the single contiguous sensing region. In operation, the input device 316 may cause rotation about the first axis in response to input objects moving into and staying in the first set of continuation regions after multiple input objects concurrently traveled along the second direction. Further, the input device 316 may cause rotation about the second axis in response to input objects moving into and staying in the second set of continuation regions after multiple input objects concurrently traveled along the first direction.

Some embodiments also have extension regions similar to those discussed above for enabling continued translation along the first axis, second axis, or both. For example, the input device 316 may cause continued translation along the first axis in response to an input object moving into and staying in a first set of extension regions after the input object has traveled along the first direction. Further, the input device 316 may cause continued translation along the second axis in response to an input object moving into and staying in the second set of continuation regions after the input object has traveled along the second direction.

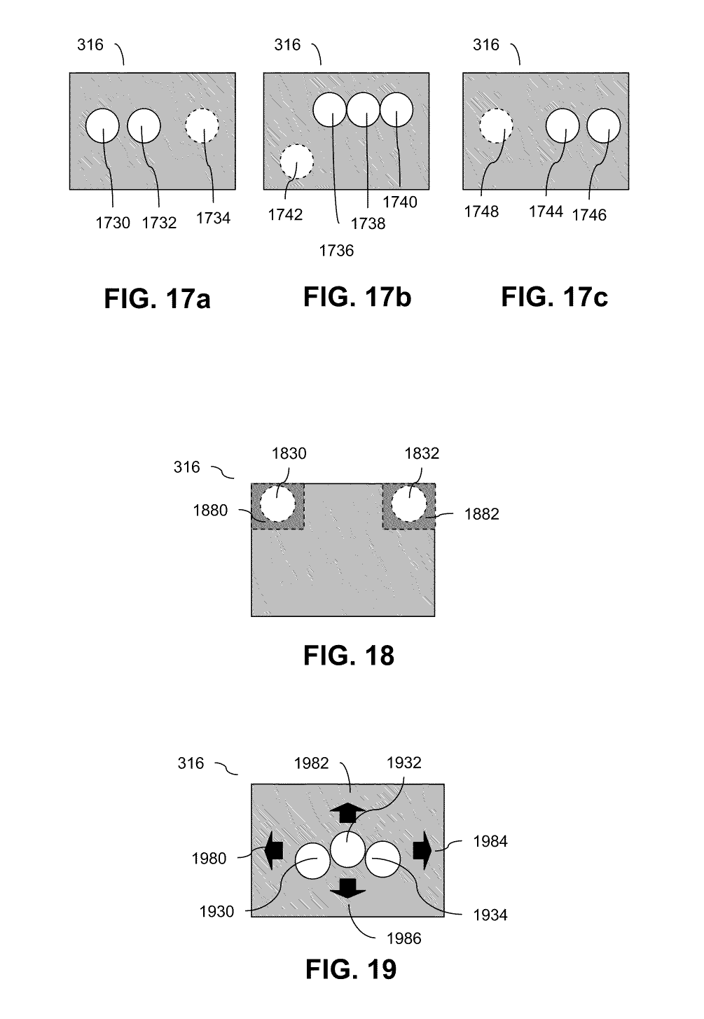

FIGS. 17a-17c show input devices with change-in-input-object-count continuation control capability, in accordance with embodiments of the invention. For example, changes in the number of input objects in the sensing region can be used to continue rotation. In some embodiments, an increase in the number of input objects that immediately or closely follows an earlier input for causing rotation about Axis 3 (not shown) results in continued rotation about Axis 3. The continued rotation about Axis 3 may continue for the duration in which the additional input object(s) stay in the sensing region. The continuation of rotation can be accomplished using any of the methods described above. For example, to continue rotation about Axis 3, the system may monitor for user input that comprises a first part involving at least one of a plurality of input objects moving in a circular manner and a second part involving at least one additional finger entering the sensing region. As another example, the input device 316 may indicate continued rotation about a first axis in response to a particular determination. Specifically, the system may determine that the user input comprises an increase in a count of input objects in the sensing region. The increase in the count of input objects may be referenced to a count of input objects associated with the contemporaneous motion of the multiple input objects that caused rotation about the first axis (e.g. having a component in the first direction, in some embodiments). The input device 316 may use timers, counters, and the like to impose particular time requirements by which additional input objects may be added to continue rotation. For example, at least one input object may need to be added by a reference amount of time. As another example, at least two input objects may need to be added within a particular reference amount of time.

FIG. 17a shows the prior presence of input objects 1730 and 1732, which already performed a gesture that caused rotation, and the addition of input object 1734 to continue the rotation. FIG. 17b shows the prior presence of input objects 1736, 1738, and 1740, followed by the addition of input object 1742 to continue the rotation. The configuration shown in FIG. 17b may be very applicable for input by the pointer, middle, and ring fingers of a right hand, and then touch-down of the thumb of the right hand. FIG. 17c shows the prior presence of input objects 1744 and 1746, followed by the addition of input object 1748 to continue the rotation. The configuration shown in FIG. 17c may be quite applicable to two-handed interactions, where input object 1748 is a digit of one hand, and input objects 1744 and 1746 are digits of another hand.

In many embodiments, input device 316 supports more than a single multi-degree of freedom control mode. To facilitate this, input device 316 or the electronic system in operative communication with input device 316 may be configured to accept mode-switching input to switch from a multi-degree of freedom control mode to one or more other modes. The other modes may be another multi-degree of freedom control mode with the same or a different number of degrees of freedom (e.g. to a 2-D mode, to another reference system, to manipulate a different object, etc.) or a mode for other functions (e.g. menu navigation, keyboard emulation, etc.). Different mode-switching input may be defined to switch to particular modes, or the same mode-switching input may be used to toggle between modes.

Being able to switch between different control modes may enable users to use the same input device 316 and similar gestures to control environments with more than six degrees of freedom. One example of a 3D environment with more than six degrees of freedom is the control of a wheeled robot with a camera, vehicle, and manipulation arm. A moveable camera view of the robot environment may involve five DOF (e.g. 3D translation, plus rotation about two of the axes). A simple robot vehicle may involve at least three DOF (e.g. 2D translation, plus rotation about one axis) and a simple robot arm may involve two DOF (e.g. rotation about two axes). Thus, control of this robot and camera view of the environment involves at least three different controllable objects (and thus at least three potential reference systems, if reference systems specific to each controlled object is used) and ten degrees of freedom. To facilitate user control of this 3D environment, the system may be configured to have at least a camera view mode, a vehicle mode, and a robot arm mode between which the user can switch.

FIG. 18 shows an input device 316 with region-based control mode switching capability, in accordance with an embodiment of the invention. Specifically, input device 316 has two mode switching regions 1880 and 1882 at corners of the sensing region of input device 316. Simultaneous input by input objects (e.g. input objects 1830 and 1832) to these mode switching regions 1880 and 1882 causes switching to another mode. The mode switching may occur at, or after a duration of time has passed after, the entry or exit of input objects to the mode switching regions 1880 and 1882. Various criteria can be used to qualify the mode switching input. For example, the input objects may be required to enter or leave the mode switching regions 1880 and 1882 substantially simultaneously, to stay within mode switching regions 1880 and 1882 for a certain amount of time, exhibit little or no motion for some duration, any combination of the above, and the like.

As a specific example of mode switching, an input device 316 may have a default input mode for emulating a conventional 2D computer mouse. Switching from this 2D mouse emulation mode to a 6 DOF control mode may require a specific gesture input to the input device 316. The specific gesture input may comprise two fingers touching two corners of the sensing region of input device 316 simultaneously. Repeating the specific gesture input may switch back to the convention 2D mouse emulation mode. After switching away from the 2D mouse emulation mode, the input device 316 may temporarily suppress mouse emulation outputs (e.g. mouse data packets).

Other examples of mode-switching input options include at least one input object tapping more than 3 times, at least three input objects entering the sensing region, and the actuation of a key. The mode-switching input may be qualified by other criteria. For example, the at least one input object may be required to tap more than 3 times within a certain duration of time. As another example, at least three input objects entering the sensing region may mean multiple fingers simultaneously entering the sensing region multiple times, such as exactly 5 input objects entering the sensing region. As another example, the actuation of a key may mean a specific type of actuation of a specific key, such as a double click or a triple click of a key such as the “CONTROL” key on keyboard.

In operation, the input device 316 may be configured to indicate or enter a particular 3-dimensional degree of freedom control mode in response to a determination that the user input comprises a mode-switching input. The mode-switching input may comprise multiple input objects simultaneously in specified portions of the single contiguous sensing region. As an alternative or an addition, the mode-switching input may comprise at least one input object tapping more than 3 times in the sensing region, at least three input objects substantially simultaneously entering the sensing region, an actuation of a mode-switching key, or any combination thereof.

The input device 316 or the electronic system associated with it may provide feedback to indicate the mode change, the active control mode, or both. The feedback may be audio, visual, affect some other sense of the user, or a combination thereof. For example, if input device 316 is set up as a touch screen, such that the sensing region is overlapped with a display screen that can display graphical images visible through the sensing region, then visual feedback may be provided relatively readily.

Returning to the robot example described above, the control mode may be switched from a conventional 2D mouse mode to a camera view control mode. The touch screen may display an image of a camera to indicate that the currently selected control mode is the camera view control mode. In the camera view control mode, user input by single or multiple input objects may be used to control the 5 DOF of the camera view. The control mode may then be changed from the camera view control mode to the vehicle control mode by a mode-switching input, such as the simultaneous input to two corners on sensor pad. In response, the system mode changes to the vehicle control mode and the touch screen may display an image of a vehicle to indicate that the currently selected control mode is the vehicle control mode. Depending on the embodiment, the same or a different mode-switching input may be used to change the control mode from the vehicle control mode to the robot arm control mode. The touch screen may display an image of a robot arm to indicate that the currently selected control mode is the robot arm control mode.

Given the capabilities of a touch screen implementation, the image displayed through the sensing region can be made to interact with user input. For example, the image may allow user selection of particular icons or options displayed on the touch screen. As a specific example, if a robot has many arm components, each with its own set of DOF, the image may be rendered interactive so that users can select which arm component is to be controlled by interacting with the touch screen. Where the robot has a top arm component and a bottom arm component, the touch screen may display a picture with the entire arm. The user may select the bottom arm component by inputting to the part of the sensing region corresponding to the bottom arm component. Visual feedback may be provided to indicate the selection to the user. For example, the touch screen may display a color change to the bottom arm component or some other item displayed after user selection of the bottom arm component. After selection of the bottom arm component, the user may rotate the bottom arm component by using rotation input such as the sliding of two fingers in the sensing region of the input device 316.

FIGS. 19-21 shows an input device 316 capable of accepting simultaneous input by three input object to control functions other than degrees of freedom, such as to control avatar face expressions, in accordance with an embodiment of the invention. That is, embodiments of this invention may be used for many other controls aside from DOF control.

As shown in FIG. 19, three input objects 1930, 1932, and 1934 are shown in the sensing region of the input device 316. These input objects 1930, 1932, and 1934 may cause different responses by moving substantially together in trajectories largely in directions 1980, 1982, 1984, or 1986. As one example, the different responses may be different “face expression” commands to a computer avatar. In some embodiments, in response to a user simultaneously placing three input fingers at touchdown, and then sliding those three fingers in the directions 1980, 1982, 1984, or 1986, this causes an avatar to change facial expressions to different degrees of “Happiness”, “Sadness”, “Love”, or “Hatred.”

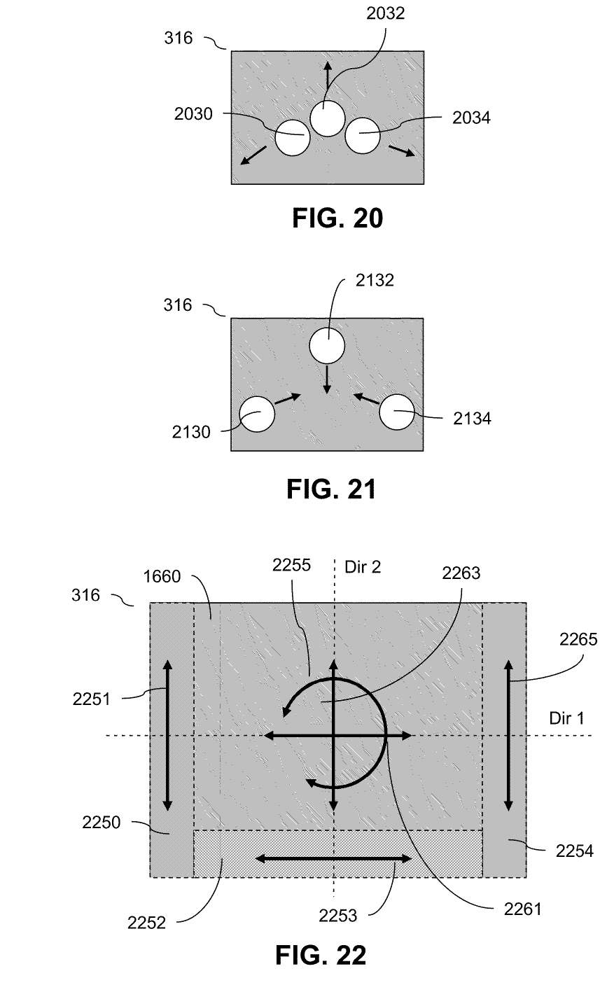

FIGS. 20-21 show input devices capable of accepting simultaneous input by three input objects, in accordance with embodiment of the invention. FIG. 20 shows three input objects 2030, 2032, and 2034 moving apart from each other. FIG. 21 shows three input objects 2130, 2132, and 2134 moving towards each other. These types of input may be used for various commands, including those related or unrelated to degree of freedom manipulation. They may also be used together to generate a more complex response. For example, the gesture shown in FIG. 20 may be used to spread the arms of a computer avatar, and the gesture shown in FIG. 21 may be used to close the arms of the computer avatar. Used together, these two gestures may cause the result of a “virtual hug” by the avatar.

FIG. 22 shows an input device 316 capable of accepting input by a single input object for controlling multiple degrees of freedom, in accordance with an embodiment of the invention. For example, the input device 316 can be used to support 6 DOF control command generation based on input by a single object in the sensing region of input device 316. In one embodiment, to help make input and gestures used to control 6 DOF more intuitive, the direction of movement by the input object (not shown) is made to emulate that of a controlled object in the 3D computer environment. That is, input object movement along Dir 1 (e.g. along arrow 2261) causes translation along Axis 1 of the controlled object (not shown) and movement along Dir 2 (e.g. along arrow 2263) causes translation along Axis 2 of the controlled object. Translation of the controlled object along Axis 3 may be controlled by input object motion (e.g. along arrow 2265) that starts in an edge region 2254 (shown along a right edge) of the input device 316. In some embodiments, input device 316 may require that the object motion stay in edge region 2254 for translation along Axis 3 to occur, although that need not be the case.

Rotation about Axis 1 can be caused by input object movement (e.g. along arrow 2251) in an edge region 2250 (e.g. along a left edge) of input device 316. In some embodiments, input device 316 may require that the object motion stay in edge region 2250 for rotation about Axis 1 to occur, although that need not be the case. Rotation about Axis 2 can be caused by input object movement (e.g. along arrow 2253) in an edge region 2252 (e.g. along a bottom edge, sometimes referred to as a back edge, as it is often farther from an associated display screen) of input device 316. In some embodiments, input device 316 may require that the object motion stays in edge region 2252 for rotation about Axis 2 to occur, although that need not be the case. Rotation about Axis 3 can be caused by input object movement (e.g. along arrow 2255) in a circular trajectory on the sensor pad. In some embodiments, input device 316 may require that the object motion stay in inner region 1660 (and outside of edge regions 2250, 2252, and 2254) for rotation about Axis 3 to occur, although that need not be the case.

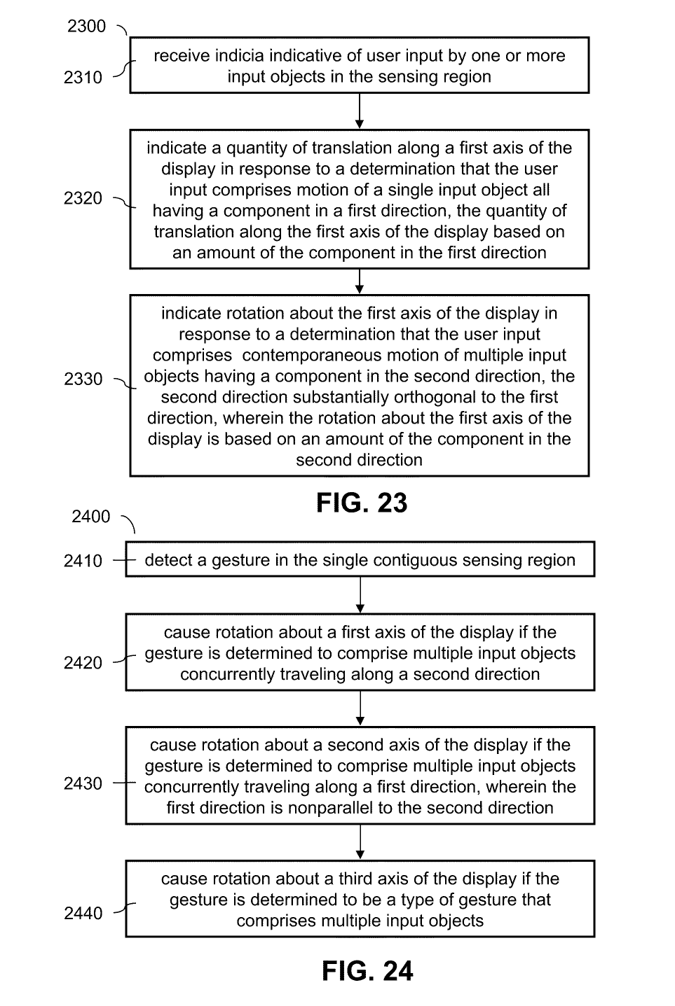

FIGS. 23-24 are flow charts of exemplary methods in accordance with embodiments of the invention. It should be understood that, although FIGS. 23-24 show parts of the method in a particular order, embodiments need not use the order shown. For example, steps may be performed in some other order than shown, or some steps may be performed more times than other steps. In addition, embodiments may include additional steps that are not shown.

Referring now to FIG. 23, flowchart depicts a method 2300 for controlling multiple degrees of freedom of a display in response to user input in a sensing region. The sensing region may be separate from the display. Step 2310 involves receiving indicia indicative of user input by one or more input objects in the sensing region of an input device. Step 2320 involves indicating a quantity of translation along a first axis of the display in response to a determination. This determination of step 2320 may be that the user input comprises motion of a single input object having a component in a first direction. The quantity of translation along the first axis of the display may be based on an amount of the component in the first direction. Step 2330 involves indicating rotation about the first axis of the display in response to a determination. This determination of step 2330 may be that the user input comprises contemporaneous motion of multiple input objects having a component in the second direction. The second direction may be substantially orthogonal to the first direction, and the rotation about the first axis of the display may be based on an amount of the component in the second direction.

As discussed above, different embodiments may perform the steps of method 2300 in a different order, repeat some steps while not others, or have additional steps.

For example, an embodiment may also include a step to indicate a quantity of translation along a second axis of the display in response to a determination. This determination may be that the user input comprises motion of a single input object having a component in the second direction. The second axis may be substantially orthogonal to the first axis, and the quantity of translation along the second axis of the display may be based on an amount of the component of the single input object in the second direction.

An embodiment may also include a step to indicate rotation about the second axis of the display in response to a determination. This determination may be that the user input comprises contemporaneous motion of multiple input objects all having a component in the first direction. The rotation about the second axis of the display may be based on an amount of the component of the multiple input objects in the first direction.

As another example of potential additional steps, embodiments may include a step to indicate translation along a third axis of the display in response to a determination that the user input comprises a change in separation distance of multiple input objects. The third axis may be substantially orthogonal to the display, if the display includes a substantially planar surface. As an alternative or an addition, embodiments may include a step to indicate rotation about the third axis of the display in response to a determination that the user input comprises circular motion of at least one input object of a plurality of input objects in the sensing region.

Embodiments may include a step to indicate continued translation along the third axis of the display in response to a determination of a continuation input. The continuation input may comprise multiple input objects moving into and staying within extension regions after a change in separation distance of the multiple input objects. The extension regions may comprise opposing corner portions of the sensing region.

Embodiments may include a step to indicate continued rotation about the first axis in response to a determination of a continuation input. The continuation input may comprise multiple input objects moving into and staying in one of a set of continuation regions after motion of the multiple input objects having the component in the second direction. The set of continuation regions may comprise opposing portions of the sensing region. As an alternative or an addition, the continuation input may comprise an increase in a count of input objects in the sensing region. The increase in the count of input objects may be referenced to a count of input objects associated with contemporaneous motion of the multiple input objects having the component in the first direction.

Embodiments may include a step to indicate a particular 3-dimensional degree of freedom control mode in response to a determination that the user input comprises a mode-switching input.

Referring now to FIG. 24, flowchart depicts a method 2400 for controlling multiple degrees of freedom of a display using a single contiguous sensing region of a sensing device. The single contiguous sensing region may be separate from the display. Step 2410 involves detecting a gesture in the single contiguous sensing region. Step 2420 involves causing rotation about a first axis of the display if the gesture is determined to comprise multiple input objects concurrently traveling along a second direction. Step 2430 involves causing rotation about a second axis of the display if the gesture is determined to comprise multiple input objects concurrently traveling along a first direction, wherein the first direction is nonparallel to the second direction. Step 2440 involves causing rotation about a third axis of the display if the gesture is determined to be another type of gesture that comprises multiple input objects. It should be understood that, in some configurations, the type of gesture that comprises multiple input objects may be the same as the gestures described in connection with steps 2420 or 2430, or may have aspects that duplicate part or all of the gestures described in connection with steps 2420 or 2430. In such configurations, this type of gesture causes rotation about the first or second axis as appropriate (e.g. in particular modes, for particular applications, etc.), in addition to causing rotation about the third axis. In other configurations, the type of gesture that comprises multiple input objects is different from the gestures described in connection with steps 2420 or 2430. In such configurations, this type of gesture may cause rotation about the third axis only, and not rotation about the first or second axes.

As discussed above, different embodiments may perform the steps of method 2400 in a different order, repeat some steps while not others, or have additional steps.

In some embodiments, the first and second axes are substantially orthogonal to each other, and the first and second directions are substantially orthogonal to each other. Also, an amount of rotation about the first axis may be based on a distance of travel of the multiple input objects along the second direction, and an amount of rotation about the second axis may be based on a distance of travel of the multiple input objects along the first direction.

In some embodiments, the display is substantially planar, the first and second axes are substantially orthogonal to each other and define a plane substantially parallel to the display, and the third axis of the display is substantially orthogonal to the display. Also, some embodiments may include the step of causing translation along the first axis of the display if the gesture is determined to comprise a single input object traveling along the first direction. An amount of translation along the first axis may be based on a distance of travel of the single input object along the first direction. As an alternative or an addition, some embodiments may include the step of causing translation along the second axis of the display if the gesture is determined to comprise a single input object traveling along the second direction. Similarly, an amount of translation along the first axis may be based on a distance of travel of the single input object along the second direction. Also, embodiments may include the step of causing translation along the third axis of the display if the gesture is determined to comprise a change in separation distance of multiple input objects with respect to each other, or at least four input objects concurrently moving substantially in a same direction.

Embodiments may determine that a type of gesture that comprises multiple input objects comprises circular motion of at least one of the multiple input objects, such that embodiments may cause rotation about the third axis of the display if the gesture is determined to comprise circular motion of at least one of the multiple input objects.

In response to gestures that include object motion along both first and second directions, some embodiments may cause the result associated with the predominant direction of the object motion. That is, some embodiments may determine if the gesture comprises multiple input objects concurrently traveling predominantly along the second (or first) direction, such that rotation about the first (or second) axis of the display occurs only if the gesture is determined to comprise the multiple input objects concurrently traveling predominantly along the second (or first) direction. Determining object motion as predominantly along the second (or first) direction may comprise determining that object motion is not predominantly along the first (or second) direction. The first and second directions may be pre-defined.

In response to gestures that include object motion along both first and second directions, some embodiments may cause the result that mixes responses associated with object motion in the first direction and object motion in the second direction. That is, some embodiments may determine an amount of rotation about the first axis based on an amount of travel of the multiple input objects along the second direction, and determine an amount of rotation about the second axis based on an amount of travel of the multiple input objects along the first direction. The amount of rotation determined in the first and second axes may be superimposed or combined in some other manner such that multiple input objects concurrently traveling along both the second and first directions causes rotation about both the first and second axes. Some embodiments may filter out or disregard smaller object motion in the second direction if the primary direction of travel is in the first direction (or vice versa), such that mixed rotation responses do not result from input that are substantially in the first direction (or the second direction).

Embodiments may also have continuing rotate regions for continuing rotation. Some embodiments have sensing regions that comprise a first set of continuation regions. The first set of continuation regions may be at first opposing outer portions of the sensing region. Such embodiments may include the step of causing rotation about the first axis in response to input objects moving into and staying in the first set of continuation regions after multiple input objects concurrently traveled along the second direction. Some embodiments also have a second set of continuation regions. The second set of continuation regions may be at second opposing outer portions of the single contiguous sensing region. Such embodiments may include the step of causing rotation about the second axis in response to input objects moving into and staying in the second set of continuation regions after multiple input objects concurrently traveled along the first direction.

Embodiments may also be configured to continue rotation, even if no further object motion occurs, in response to an increase in input object count. For example, embodiments may include the step of causing continued rotation in response to an increase in a count of input objects in the single contiguous sensing region after multiple input objects concurrently traveled in the single contiguous sensing region.

Embodiments may be configured to continue translation along the third axis in response to input in corner regions or multiple input objects converging in the same region. For example, an embodiment may have a sensing region that comprises a set of extension regions at diagonally opposing corners of the sensing region. The embodiment may comprise the additional step of causing continued translation along the third axis of the display in response to input objects moving into and staying in the extension regions after a prior input associated with causing translation along the third axis. Such a prior input may comprise multiple input objects having moved relative to each other in the sensing region such that a separation distance of the multiple input objects with respect to each other changes. As an alternative or an addition, an embodiment may include the step of causing continued translation along the third axis of the display in response to input objects moving into and staying in a same portion of the single contiguous sensing region after a prior input associated with translation along the third axis.

Embodiments may also have mode-switching capability (e.g. switching to a 2D control mode, another 3D control mode, some other multi-degree of freedom control mode, or some other mode), and include the step of entering a particular 3-dimensional degree of freedom control mode in response to a mode-switching input. The mode-switching input may comprise multiple input objects simultaneously in specified portions of the single contiguous sensing region. This mode switching input may be detected by the embodiments watching for multiple input objects substantially simultaneously entering specified portions of the single contiguous sensing region, multiple input objects substantially simultaneously tapping in specified portions of the single contiguous sensing region, multiple input objects substantially simultaneously entering and leaving corners of the single contiguous sensing region, and the like. As an alternatively or an addition, the mode-switching input may comprise at least one input selected from the group consisting of: at least one input object tapping more than 3 times in the single contiguous sensing region, at least three input objects substantially simultaneously entering the single contiguous sensing region, and an actuation of a mode-switching key.

The methods described above may be implemented in a proximity sensing device having a single contiguous sensing region. The single contiguous sensing region is usable for controlling multiple degrees of freedom of a display separate from the single contiguous sensing region. The proximity sensing device may comprise a plurality of sensor electrodes configured for detecting input objects in the single contiguous sensing region. The proximity sensing device may also comprise a controller in communicative operation with plurality of sensor electrodes. The controller is configured to practice any or all of the steps described above in various embodiments of the invention.

What is claimed is:

1. A program product comprising:
(a) a sensor program for controlling multiple degrees of freedom of a display in response to user input in a sensing region separate from the display, the sensor program configured to:
receive indicia indicative of user input by one or more input objects in the sensing region;
indicate a quantity of translation along a first axis of the display in response to a determination that the user input comprises motion of a single input object having a component in a first direction, the quantity of translation along the first axis of the display based on an amount of the component in the first direction; and
indicate rotation about the first axis of the display in response to a determination that the user input comprises contemporaneous motion of multiple input objects having a component in the second direction, the second direction substantially orthogonal to the first direction, wherein the rotation about the first axis of the display is based on an amount of the component in the second direction; and
(b) computer-readable media bearing the sensor program

2. The program product of claim 1, wherein the sensor program is further configured to:
indicate a quantity of translation along a second axis of the display in response to a determination that the user input comprises motion of a single input object having a component in the second direction, the second axis substantially orthogonal to the first axis, wherein the quantity of translation along the second axis of the display is based on an amount of the component of the single input object in the second direction;
indicate rotation about the second axis of the display in response to a determination that the user input comprises contemporaneous motion of multiple input objects all having a component in the first direction, the rotation about the second axis of the display based on an amount of the component of the multiple input objects in the first direction.

3. The program product of claim 1 wherein the display is substantially planar, and wherein the sensor program is further configured to:
indicate translation along a third axis of the display in response to a determination that the user input comprises a change in separation distance of multiple input objects, wherein the third axis is substantially orthogonal to the display;
indicate rotation about the third axis of the display in response to a determination that the user input comprises circular motion of at least one input object of a plurality of input objects in the sensing region.

4. The program product of claim 3, wherein the sensor program is further configured to:
indicate continued translation along the third axis of the display in response to a determination that the user input comprises the multiple input objects moving into and staying within extension regions after the change in separation distance of the multiple input objects, the extension regions comprising opposing corner portions of the sensing region.

5. The program product of claim 1, wherein the sensor program is further configured to:
indicate continued rotation about the first axis in response to a determination that the user input comprises the multiple input objects moving into and staying in a set of continuation regions after the motion of the multiple input objects having the component in the second direction, the set of continuation regions comprising opposing portions of the sensing region.

6. The program product of claim 1, wherein the sensor program is further configured to:
indicate continued rotation about the first axis in response to a determination that the user input comprises an increase in a count of input objects in the sensing region, the increase in the count of input objects being referenced to a count of input objects associated with the contemporaneous motion of the multiple input objects having the component in the second direction.

7. The program product of claim 1, wherein the sensor program is further configured to:
indicate a particular 3-dimensional degree of freedom control mode in response to a determination that the user input comprises a mode-switching input.

8. A method for controlling multiple degrees of freedom of a display using a single contiguous sensing region of a sensing device, the single contiguous sensing region being separate from the display, the method comprising:
detecting a gesture in the single contiguous sensing region;
causing rotation about a first axis of the display if the gesture is determined to comprise multiple input objects concurrently traveling along a second direction;
causing rotation about a second axis of the display if the gesture is determined to comprise multiple input objects concurrently traveling along a first direction, wherein the first direction is nonparallel to the second direction; and
causing rotation about a third axis of the display if the gesture is determined to be another type of gesture that comprises multiple input objects.

9. The method of claim 8 wherein the first and second axes are substantially orthogonal to each other, wherein the first and second directions are substantially orthogonal to each other, and wherein
the causing rotation about a first axis of the display if the gesture is determined to comprise multiple input objects concurrently traveling along a second direction comprises:
determining an amount of rotation about the first axis based on a distance of travel of the multiple input objects along the second direction, and wherein
the causing rotation about a second axis of the display if the gesture is determined to comprise multiple input objects concurrently traveling along a first direction comprises:
determining an amount of rotation about the second axis based on a distance of travel of the multiple input objects along the first direction.

10. The method of claim 8 wherein the display is substantially planar, wherein the first and second axes are substantially orthogonal to each other and define a plane substantially parallel to the display, and wherein the third axis of the display is substantially orthogonal to the display, the method further comprising:
causing translation along the first axis of the display if the gesture is determined to comprise a single input object traveling along the first direction, wherein an amount of translation along the first axis is based on a distance of travel of the single input object along the first direction;
causing translation along the second axis of the display if the gesture is determined to comprise a single input object traveling along the second direction, wherein an amount of translation along the first axis is based on a distance of travel of the single input object along the second direction; and
causing translation along the third axis of the display if the gesture is determined to comprise at least one of a change in separation distance of multiple input objects, with respect to each other and at least four input objects concurrently moving substantially in a same direction, wherein
the causing rotation about a third axis of the display if the gesture is determined to be a type of gesture that comprises multiple input objects comprises:
causing rotation about the third axis of the display if the gesture is determined to comprise circular motion of at least one of the multiple input objects

11. The method of claim 8, wherein the first direction and the second direction are predefined, and wherein
the causing rotation about a first axis of the display if the gesture is determined to comprise multiple input objects concurrently traveling along a second direction comprises:
determining if the gesture comprises multiple input objects concurrently traveling predominantly along the second direction, such that rotation about the first axis of the display occurs only if the gesture is determined to comprise the multiple input objects concurrently traveling predominantly along the second direction, and wherein
the causing rotation about a second axis of the display if the gesture is determined to comprise multiple input objects concurrently traveling along a first direction comprises:
determining if the gesture comprises multiple input objects concurrently traveling predominantly along the first direction, such that rotation about the second axis of the display occurs only if the gesture is determine to comprise the multiple input objects concurrently traveling predominantly along the first direction.

12. The method of claim 8, wherein the first axis and second axis are substantially orthogonal to each other, and wherein the first direction and the second direction are predefined and substantially orthogonal to each other, wherein
the causing rotation about a first axis of the display if the gesture is determined to comprise multiple input objects concurrently traveling along a second direction comprises:
determining an amount of rotation about the first axis based on an amount of travel of the multiple input objects along the second direction, and wherein
the causing rotation about a second axis of the display if the gesture is determined to comprise multiple input objects concurrently traveling along a first direction comprises:
determining an amount of rotation about the second axis based on an amount of travel of the multiple input objects along the first direction, such that multiple input objects concurrently traveling along both the second and first directions would cause rotation about both the first and second axes.

13. The method of claim 8, wherein the single contiguous sensing region comprises a first set of continuation regions and a second set of continuation regions, the first set of continuation regions at first opposing outer portions of the single contiguous sensing region and the second set of continuation regions at second opposing outer portions of the single contiguous sensing region, the method further comprising:
causing rotation about the first axis in response to input objects moving into and staying in the first set of continuation regions after multiple input objects concurrently traveled along the second direction; and
causing rotation about the second axis in response to input objects moving into and staying in the second set of continuation regions after multiple input objects concurrently traveled along the first direction.

14. The method of claim 8, further comprising:
causing continued rotation in response to an increase in a count of input objects in the single contiguous sensing region after multiple input objects concurrently traveled in the single contiguous sensing region.

15. The method of claim 8, wherein the single contiguous sensing region comprises a set of extension regions at diagonally opposing corners of the single contiguous sensing region, the method further comprising:
causing continued translation along the third axis of the display in response to input objects moving into and staying in at least one of the extension regions a same portion of the single contiguous sensing region after multiple input objects has moved relative to each other in the sensing region such that a separation distance of the multiple input objects with respect to each other changes.

16. The method of claim 8, further comprising:
entering a particular 3-dimensional degree of freedom control mode in response to a mode-switching input.

17. The method of claim 16, wherein the mode-switching input comprises multiple input objects simultaneously in specified portions of the single contiguous sensing region.

18. The method of claim 16, wherein the mode-switching input comprises at least one input selected from the group consisting of: at least one input object tapping more than three times in the single contiguous sensing region, at least three input objects substantially simultaneously entering the single contiguous sensing region, and an actuation of a mode-switching key.

19. A proximity sensing device having a single contiguous sensing region usable for controlling multiple degrees of freedom of a display separate from the single contiguous sensing region; the proximity sensing device comprising:
a plurality of sensor electrodes configured for detecting input objects in the single contiguous sensing region; and
a controller in communicative operation with the plurality of sensor electrodes, the controller configured to:
receive indicia indicative of one or more input objects performing a gesture in the single contiguous sensing region;
cause rotation about a first axis of the display if the gesture is determined to comprise multiple input objects concurrently traveling along a second direction;
cause rotation about a second axis of the display if the gesture is determined to comprise multiple input objects concurrently traveling along a first direction, wherein the first direction is nonparallel to the second direction; and
cause rotation about a third axis of the display if the gesture is determined to be another type of gesture that comprises multiple input objects.

20. The proximity sensing device of claim 19 wherein the display is substantially planar, wherein the first and second axes are orthogonal to each other and define a plane substantially parallel to the display, wherein the third axis is substantially orthogonal to the display, and wherein the controller is further configured to:
cause translation along the first axis of the display if the gesture is determined to comprise a single input object traveling along the first direction, wherein an amount of translation along the first axis is based on a distance of travel of the single input object along the first direction; and
cause translation along the second axis of the display if the gesture is determined to comprise a single input object traveling along the second direction, wherein an amount of translation along the first axis is based on a distance of travel of the single input object along the second direction.
